(19) United States
(12) Patent Application Publication
(10) Pub. No.: US 2021/0082594 A1
(43) Pub. Date: Mar. 18, 2021

(54) Method And System For Generating Radioactive Isotopes For Medical Applications

(71) Applicants: Yogendra Narain Srivastava, Brookline, MA (US); John David Swain, Boston, MA (US); Georges Albert De Montmollin, Neuchâtel (CH)

(72) Inventors: Yogendra Narain Srivastava, Brookline, MA (US); John David Swain, Boston, MA (US); Georges Albert De Montmollin, Neuchâtel (CH)

(21) Appl. No.: 17/100,976

(22) Filed: Nov. 23, 2020

Related U.S. Application Data
(63) Continuation-in-part of application No. PCT/IB2019/056546, filed on Jul. 31, 2019.
(60) Provisional application No. 62/713,581, filed on Aug. 2, 2018.

(51) Int. Cl. G21G 1/10; H05H 6/00; A61K 51/02

(52) U.S. Cl. CPC G21G 1/10; H05H 9/00; A61K 51/02; H05H 6/00

(57) ABSTRACT

A method for producing radio-active isotopes using an electron accelerating machine via the one photon exchange exciting target nuclear giant dipole resonances (GDR) including the steps of providing a stable copper, carbon and/or fluorine isotope samples, and accelerating electrons by an electron accelerator to reach peak photon energies of above 10 MeV to impinge on the stable copper, carbon and/or fluorine isotope sample to generate a copper, carbon and/or fluorine medical radioisotope in a convenient safe chemical environment for medical applications.

### CROSS-REFERENCE TO RELATED APPLICATIONS

The present patent application claims benefit of priority to International patent application No. PCT/IB2019/056546 that was filed on Jul. 31, 2019 and that designated the United States, and is also a continuation-in-part (CIP) and “bypass” application under 35 U.S.C. §§ 111(a) and 365(c) of said International patent application, and also claims foreign priority to the U.S. Provisional Patent Application No. 62/713,581 that was filed on Aug. 2, 2018, both references herewith incorporated by reference in their entirety.

### FIELD OF THE INVENTION

The present invention is directed to the field of radioactive isotopes (RI) and the generation of such isotopes through the application of the photodisintegration of nuclei employing giant dipole resonances (GDR).

### BACKGROUND ART

Photo- and electro-disintegration of nuclei have been traditionally used for studying giant dipole resonances (GDR) and through them nuclear structure. More recently, through laser and smart material devices, electrons have been accelerated in condensed matter up to several tens of MeV. The possibility of inducing electro-disintegration of nuclei through such devices has been previously explored in [1], [2], and [3]. The methods involve a synthesis of electromagnetic and strong forces in condensed matter via giant dipole resonances to give an effective electro-strong interaction (ES), in the tens of MeV range. For a discussion of processes induced by electroweak reactions, see [4]. Applications of both electro-weak and electro-strong processes can be found in our two recent papers. [5], [6].

GDR are very well known across many disciplines beyond nuclear physics proper. For example, GDR mediate the energy at high nuclear energy due to dissociation within the cosmic microwave background. GDR are also well known to contribute in astrophysical nuclear synthesis. Prior to ES, Ejiri and Date [7] proposed Compton-backscattered laser photons from GeV electrons for the production of useful radioactive isotopes e.g. for medical applications via GDR. It has also been suggested that radioactive waste products such as ¹²⁹ I could be transmuted via electron beam induced GDR and their subsequent decays, with transmutations to another isotope for safety. Some of these have been carried out at New SUBARU in Japan using 1064 nm laser photons from a Nd:YVO laser, Compton scattered from a stored electron beam to energies up to 17.6 Me V. ¹²⁹ I has been transmuted using a laser-generated plasma to accelerate electrons to produce gamma rays. These excite the GDR. For a very comprehensive review of laser-driven nuclear processes, see for example [8].

Moreover, in U.S. Pat. Pub. No. 2017/0251547 of the inventor Tako Ito, radio nuclides are produced by a particle beam, where a specific target device 10 having a plurality of target material plates 20a, 20b is used for producing a radionuclide, lined up in an overlapped manner, configured to produce the radionuclide when a particle beam is irradiated on the target material plates 20a, 20b, with specific front plate groups (GRF) and rear plate groups (GRR).

Similarly, in U.S. Pat. Pub. No. 2012/0281799 of the inventors Wells et al, a method is discussed where high energy photons or gamma radiation, impinge upon a specific target comprising a nanomaterial and having specific dimensions and arrangement that includes a target isotope, resulting in the release of one or more neutrons from the target isotope. This neutron release creates an effect known as “kinematic recoil,” which results in a recoiling photo-produced radioisotope which is ejected from the nanomaterial and can be harvested in high specific activity.

Also, in U.S. Pat. Pub. No. 2008/0240330 of the inventor Charles S. Holden, a method for produce unstable short-lived medical isotopes is discussed, using an electron beam source, requiring an additional converter having a tube wall spaced apart from the electron beam source for receiving electrons from the electron beam source and converting the energy of the electrons into a tailored spectrum of gamma radiation, a first cooling system for the converter, a reaction chamber having a second cooling system for exporting heat from said reaction chamber.

However, all of these U.S. Patent Publications require specific manufacture and assembly of target materials and specific modifications to the electron beam generators, and these requirements are not usable for electron accelerators that are commonly used in hospitals for nuclear imaging.

In light of the above discussion, GDR are very well understood and employed, both theoretically and practically in devices well outside the scope of nuclear physics proper.

### SUMMARY

According to some aspects of the present invention, a novel method plus system for generating radioactive isotopes (RI) is provided. These radioactive isotopes being used or needed either but not limited to the field of nuclear imaging or for cures in nuclear medicine. The inventors employ giant dipole resonances in nuclei based on a method and system based upon an efficient use of extensive theoretical and experimental work. Electron accelerators in hospitals dealing with nuclear medicine routinely generate the required photon beams can be suitable for the production of the isotopes and methods of this invention.

According to yet another aspect of the present invention, a method for producing radio-active isotopes using an electron machine via one-photon exchange by giant dipole resonances (GDR). Preferably, the method includes the steps of providing a stable copper (or fluorocarbon) isotope sample, and accelerating electrons by an electron accelerator to a peak photon energy of above 10 MeV to impinge on the stable copper (or fluorocarbo) isotope sample to generate a copper (or carbon and fluorine) radioisotope.

According to still another aspect of the present invention, a system for producing radioactive isotopes is provided. The system preferably includes an electron machine operable to perform one-photon exchange by giant dipole resonances (GDR), configured to accelerate electrons by an electron accelerator to a peak photon energy of above 10 MeV. The electron accelerator is configured to impinge the accelerated electrons onto for example a stable copper Cu isotope sample to generate a copper radioisotope or onto a piece of Teflon (C₂F₄)ₙ to generate a carbon C or Fluorine F isotope.

According to one aspect of the present invention, the proposed method or system differs substantially from laser driven proposals discussed in the previous paragraph. Nuclear transmutation processes and experiments are proposed that utilize electro-strong (ES) interaction processes induced by the synthesis of electro-magnetic (EM) and strong forces for the production of radioisotopes (RI) needed for nuclear medicine. If the effective photon flux lies within 10^{(12÷15)}/sec., then the expected rate of RI production would be 10^{(10÷13)}/sec., corresponding to an RI density around (0.05÷50)GBq/mg.

The above and other objects features and advantages to the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 shows an exemplary Feynman diagram illustrating the production of RI according to an aspect of the present invention;

FIG. 2 exemplarily shows the absorption rate of a photon yin Teflon (C₂F₄)ₙ as a function of photon energy T;

FIG. 3 exemplarily shows the Geiger counting rate in Hz for two radioactive samples Cu as a function of time in minutes after a the gamma ray beam created the radioisotopes by GDR absorption;

FIG. 4 exemplarily shows a system 200 for producing medical radioactive isotopes using an electron accelerator 100 via a one-photon exchange into target nuclear giant dipole resonances (GDR) of a isotope sample;

FIG. 5 exemplarily shows a graph of the activity of ⁶²Cu and ⁶⁴Cu as a function of time. The vertical line represents the moment when the electron beam has been switched off;

FIG. 6 exemplarily shows a graph comparing theoretical vs measured total activity of Cu RI (in Bq) as a function of time;

FIG. 7A exemplarily shows the spectrum of the first Teflon target sample after irradiation, and the annihilation peak (511 keV) is clearly visible, and FIG. 7B shows exemplarily the spectrum of the second Teflon target after irradiation. The annihilation peak (511 keV) is again very visible;

FIG. 8A exemplarily shows a graph representing the zoomed spectrum of the first target (13.105 g) after irradiation (annihilation peak), and FIG. 8B exemplarily shows a graph representing the zoomed spectrum of the second target (3.205 g) after irradiation (annihilation peak);

FIG. 9A exemplarily shows a graph with the decay data and at to the activity for the first Teflon sample, and FIG. 9B exemplarily shows a graph with the decay data and at to the activity for the second Teflon sample.

Herein, identical reference numerals are used, where possible, to designate identical elements that are common to the figures. Also, the images are simplified for illustration purposes and may not be depicted to scale.

### DETAILED DESCRIPTION OF THE SEVERAL EMBODIMENTS

Over several decades, virtual photons from electron scattering as well as Bremsstrahlung photons have been routinely used to cause nuclear photodisintegration via the generation of giant dipole resonances (GDR) in the intermediate state. The reactions studied extensively are with production of one or two neutrons such as

A+γ*→n+A*

A+γ*→n+n+A*

where γ* is the virtual photon from electron scattering and A* stands for the nuclear disintegration product. Of course, their counterpart nuclear breakup reactions and two neutron production reactions from real photons have also been of continuous interest and study. Typically, GDR's are in the (10-20) MeV range for heavy nuclei and (15-25) MeV for light nuclei, to follow the equation 15 MeV<E<25 MeV. Detailed experimental compendia [9] of GDR energies are available for a variety of applications.

In the above types of electron beam experiments, it is not simple to measure the amounts of transmuted nuclei since the recoil from the momentum hit of the gamma is at very low non-relativistic velocities. The transmuted nuclei thereby in dominant probability do not escape from the target. The object here is to provide the means for measuring the chemical concentrations within the target of the final nuclei. GDR produce neutron concentrations that are quite high in the range of about 10⁻³ to 10⁻² per electron in the beam on thick targets, 10²>xₙₑᵤₜᵣₒₙ>10³.

With respect to endothermic fission and other transmutations, fission is usually considered for nuclei heavy compared with iron since the GRD are then on the low energy side of the binding curve. The light nuclei require a higher energy for fission disintegration. However, very little has been done in measuring the decay products of DGR fission in lighter nuclei beyond directly counting fast neutrons.

If tens of MeV are present in simple condensed matter systems and with the giant dipole resonances available, then endothermic fission reactions may be more interesting and more common than have been typically thought. Looking for new elements or new isotopes not present originally would indicate the occurrence of nuclear reactions in addition to the simple detection of neutrons many of which may be too slow to make it to detectors but which could reveal themselves through further transmutations. We emphasize that since the processes considered here, unlike earlier electroweak low energy nuclear reactions, are not suppressed by the Fermi constant, the scale at which transmutations occur could be very large. Weak decay rates may be of the order of a thousand times lower or may be more than the electro-strong photodisintegration rates.

Of course one can also expect increased rates for exothermic fission reactions, such as increased rates of spontaneous nuclear fission processes. Whatever nuclei are produced, they may in turn undergo further reactions such as decays (weak or strong or through emission of gamma rays) and may absorb neutrons such as those produced in the initial GDR decay.

There herein presented method or system opens up a vast range of possibilities to consider with searches for new nuclei not originally present. These might be revealed via chemical means, neutron activation, electron microscopy elemental analysis, X-ray fluorescence, or other techniques. Specifically, if electrons are accelerated to tens of MeV in condensed matter systems, then one expects both endothermic and exothermic nuclear fission processes as well as the appearance of new nuclei due to further reactions of the decay products including further decays and/or the absorption of produced neutrons.

In references [2, 3], we have discussed electro-strong (ES) induced endothermic fission that can take place in addition to the more common exothermic fission and alterations in exothermic fission rates as well as other transmutations that can occur in condensed matter systems. A particularly interesting experimental example is provided in [11] in which aluminum and silicon might appear in an initial sample of iron. According to an aspect of the present invention we find the following. If electrons are accelerated to several tens of MeV in condensed matter systems containing iron, then one may expect the appearance of aluminum and silicon.

With respect to the generation of nuclear isotopes for medicine, the ES interaction method or system discussed above can be generically used for a whole host of nuclear transmutations. We have verified by observing the decay products from medical radioisotopes of Copper, Carbon, and Fluorine. The medical radioisotopes were all produced employing a standard hospital electron accelerator yielding photon beams of approximately 22 MeV in energy to photo disintegrate otherwise stable nuclei in condensed matter targets.

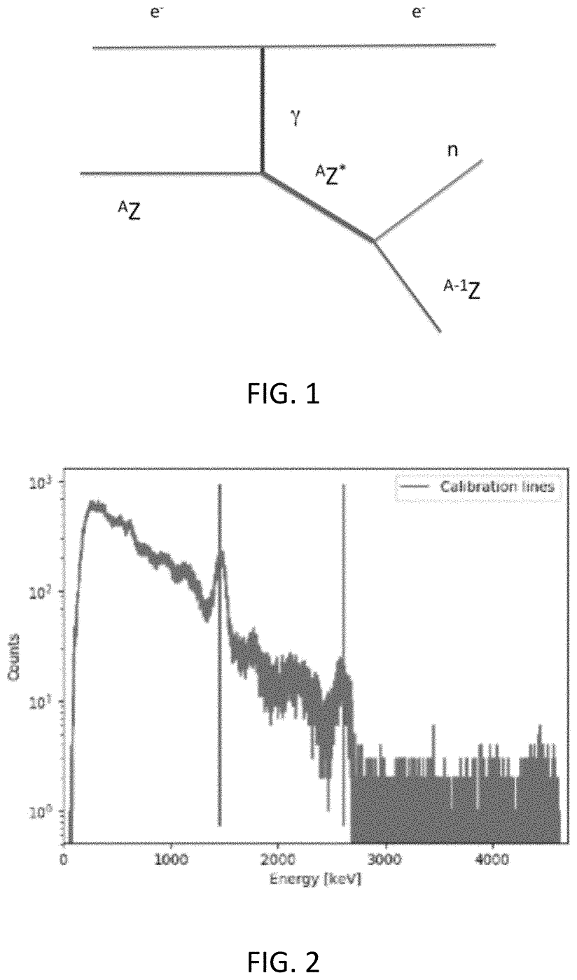

FIG. 1 exemplarily shows the electron radiates a photon γ into a nucleus having charge Z and atomic number A. The nucleus is excited into a giant dipole resonant state that disintegrates into a radioisotope with atomic number A−1 plus a neutron n. As examples we have the photodisintegration of otherwise stable naturally occurring isotopes in pure copper into medically useful radioisotopes according to the reactions

γ+⁶³Cu→⁶³ Cu*→n+⁶²Cu

γ+⁶⁵Cu→⁶⁵Cu*→n+⁶⁴Cu
Similarly, we have the photodisintegration of otherwise stable naturally occurring isotopes in Teflon into medically useful radioisotopes of Carbon and Fluorine according to the reactions

γ+¹²C→¹²C*→n+¹¹C

γ+¹⁹F→¹⁸F*→n+¹⁸F.

The photon absorption rate on Teflon in arbitrary units as a function of photon energy measured coming from a LINAC electron source is shown in the spectrum analyzer plot below in FIG. 2.

In FIG. 2, the absorption rates a photon yin Teflon (C₂F₄) are exemplarily shown as a function of photon energy. The photon source was a medical LINAC and the first red line marks the known giant dipole resonance energy of 15.1 MeV in ¹²C. The second higher energy red line broadly distributed around 24 MeV marks the giant dipole resonance in ¹⁹F.

With respect to stable and unstable isotopes of copper, we recall here that ⁶³Cu and ⁶⁵Cu are the two naturally occurring stable isotopes of Copper:
⁶³Cu: Stable; natural concentration=69.15%; Z=29; N=34; J^{P}=3/2⁻;
⁶⁵Cu: Stable; natural concentration=30.85%; Z=29N=36; J^{P}=3/2 ⁻.
   There are two short half-life isotopes of interest here that can be produced via GDR employing ES interactions. They are ⁶²Cu and ⁶⁴Cu. The latter is one of the radioisotopes (RI) frequently used in nuclear medicine and imaging.
⁶²Cu: Unstable Half-life=9.67 minutes Z=29. N=35. J^{P}=1⁺ decays by β⁺ emission into ⁶² Ni;
⁶⁴Cu: Unstable-Half-life=12. 7 hours; Z=29; N=35; J^{P}=1⁺ decays by β⁺ emission (61%) into ⁶⁴Ni; and by β⁻ emission (39%) into ⁶⁴Zn.

Production of RI ⁶⁴Cu via GDR: According to an aspect of the present invention, a method and a system is proposed to produce the above RI using an electron machine via one-photon exchange GDR is schematically as follows:

γ+⁶³Cu→⁶³Cu*→⁶²Cu+n

γ+⁶⁵Cu→⁶⁵Cu*→⁶⁴Cu+n

Only the stable A=65 Cu and not the more abundant A-63 Cu produces the desired A=64 Cu medical isotope.

We have measured the above Cu reactions employing a standard Hospital electron accelerator yielding about a 22 MeV photon beam.

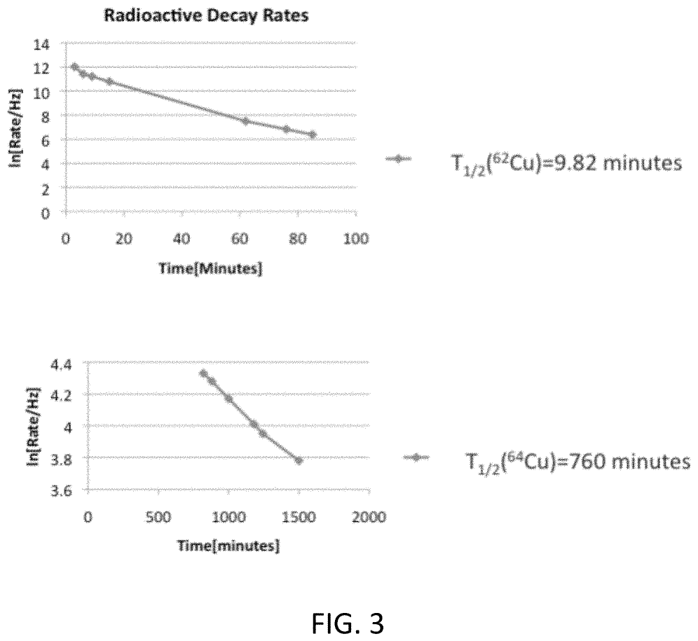

FIG. 3 shown the Geiger counting rate in Hz for two radioactive samples Cu as a function of time in minutes after a the gamma ray beam created the radioisotopes by GDR absorption. The known half-lives of the radioisotopes fit to the slopes of the curves to within a few percent of the known half-lives. The above counting curves may employed to estimate the long-lived medical radioactive isotope A=64 Cu.

Spin parity considerations seem to favor this channel. The initial nuclear ground state of ⁶⁵Cu has J^{P}=3/2⁻ and the initial photon has J^{P}=1⁻. The final state nuclear ground state ⁶⁴Cu has J^{P}=1⁺ and the final neutron has J^{P}=½⁺.

According to the compilation of GDR cross-sections on nuclei as discussed in reference [9], the parameters for the required process are as follows:

γ*+⁶⁵Cu→⁶⁴Cu+n
Peak photon energy˜18 MeV
Cross-section\ at\ the\ peak˜150\ milli-barn

Taking the initial ˜⅓ concentration in copper yields a peak cross-section for the production of the Medical radioisotope of about 45 milli barn. A useful estimate of the number of Medical radioisotopes of Cu produced per electron of the LINAC may be found in [12]. On this basis we estimate the efficiency of the processes as ˜10⁻³ Medical Cu per electron.

In sum, according to an aspect of the present invention, a novel and a relatively cheap generic method and system for generating radioisotopes of particular need in nuclear medicine is presented. The method does not employ nuclear reactors, lasers or neutron sources. Rather, use is made of commonly available hospital electron accelerators in those hospitals practicing nuclear medicine and it utilizes GDR and ES interactions. The particular case of the RI ⁶⁴Cu is presented in detail and shown to provide a local generation capability at a much-reduced cost and a fast in situ preparation.

Employing the same hospital LINAC as above to obtain a photon beam of 22 MeV impinging on a Teflon (C₂F₄) target, we observed simultaneous production of two medical radioisotopes ¹⁸F and ¹¹C via the nuclear reactions γ*+¹⁹F→n+¹⁸F; γ*+¹²C→n+¹¹C. γ+¹²C→¹²C*→n+¹¹C γ+¹⁹F→¹⁸F*→n+¹⁸F

Given the expertise and knowledge of the underlying physical mechanisms, a pre-prepared closed kit, called Y[X] can be provided. The kit in the following is specially designed for the local production of a given RI, called X as follows:

While X is too short lived to be stored over a long period of time, the kit Y[X] can be stored for long periods as it would contain only stable parent nuclei and other substances needed to properly chemically enclose X after it has been produced.

A given hospital in possession of an electron accelerator, can purchase the kit Y[X] and store it in their labs. When the radio isotope X in its proper chemical ambience is required the kit Y[X] can be directly exposed to the beam and the radio isotope X, in its properly designed material environment can be produced ready for its employment with little or no loss of time.

According to an aspect of the invention, the kit Y[X] can be designed for specific use by the end user. For example, the end user in a hospital, e.g. technician, clinician or researcher, may obtain a given amount of ⁶⁴CuCl₂⁶⁴CuCl₂ to inject into a subject. Clearly other chemical preparations presently in use may be employed.

This chemical isotope may be used either as a tracer or as a therapeutic tool. The chosen amount of the chemical corresponds to a given level of radiation emitted by the radionuclide that the user wants for a specific imaging application. The production mechanism described in the present patent application to estimate the electron beam configuration, for example but not limited to the beam energy, the scattering angle, the intensity, the amount and dimensions of the material, necessary to produce the prescribed amount of the radio nuclide from naturally occurring Copper. Similar statements can be made for medical Carbon and Fluorine medical isotopes that may employed for positron PET scans.

The kit would provide a stable Copper or Teflon sample of dimensions suitable for the purpose along with prescriptions, e.g. for the amount of beam time for electron irradiation and other information to produce required amounts of radionuclide.

Once the radio nuclide is produced in loco, the user would have to follow the usual procedures to separate it from the rest of the material, pass it through an HCl solution for example, and save it say as a radioactive salt for further use.

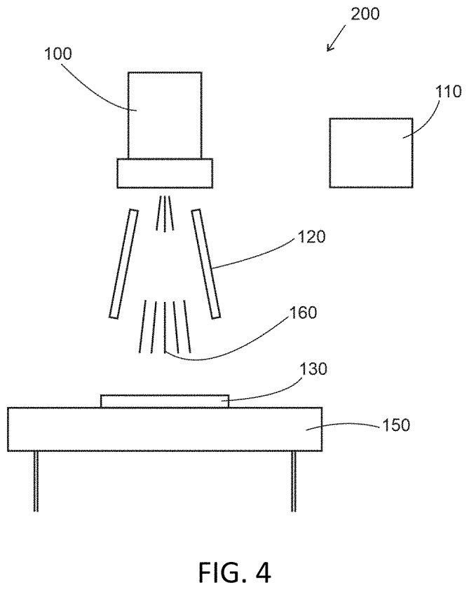

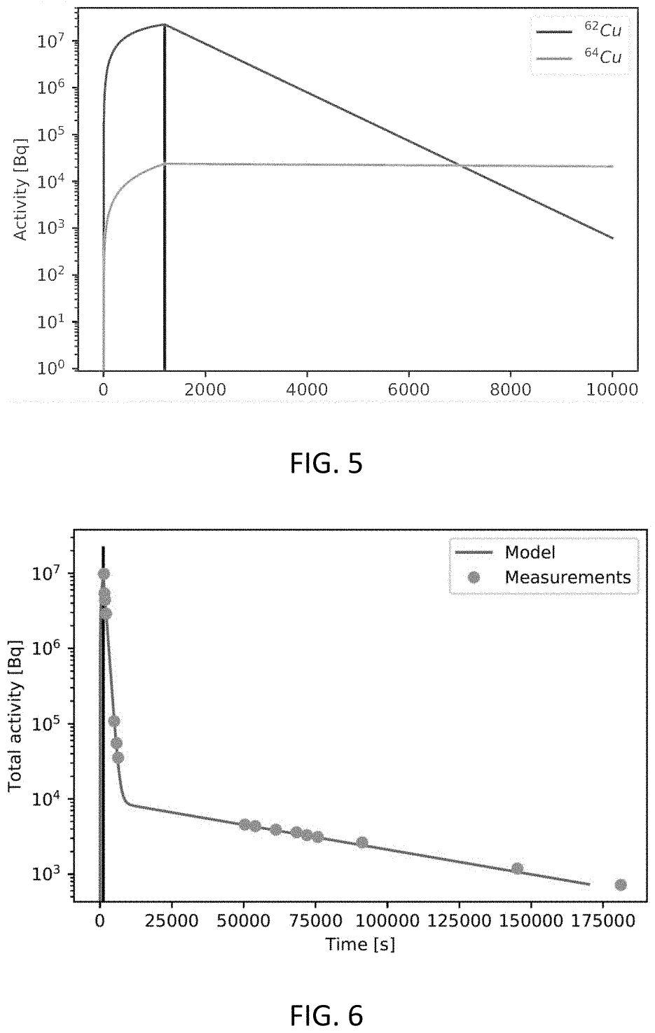

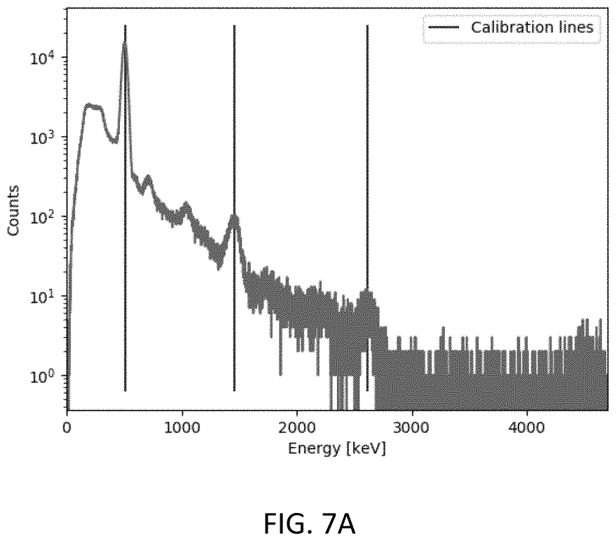

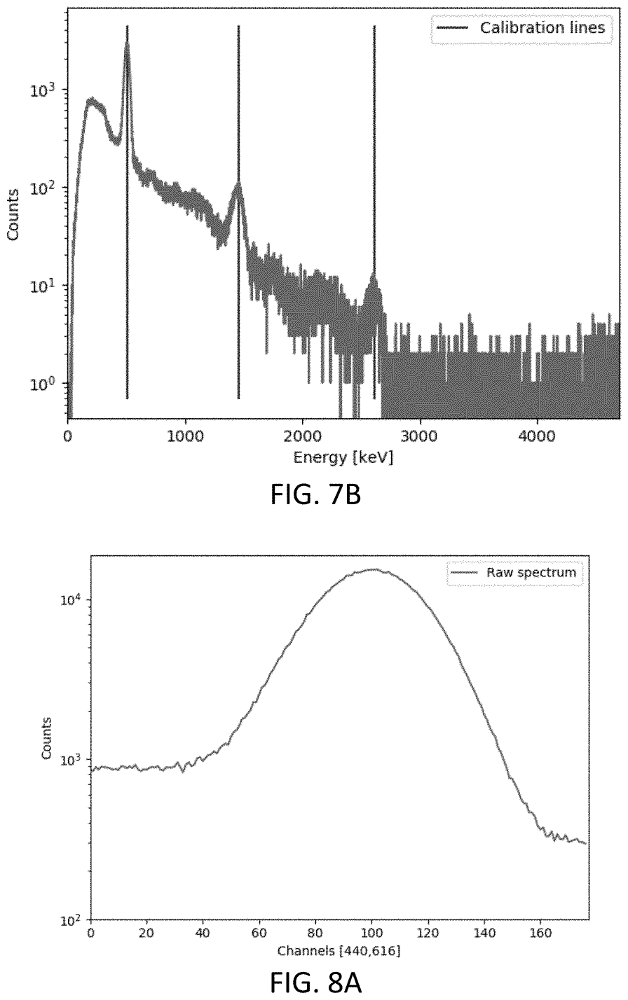

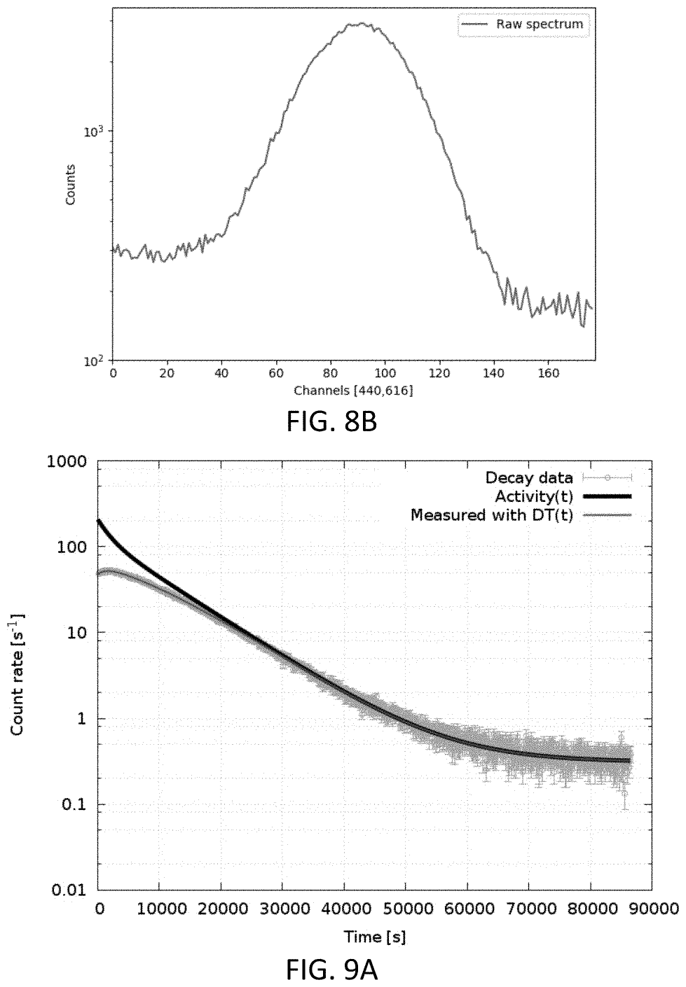

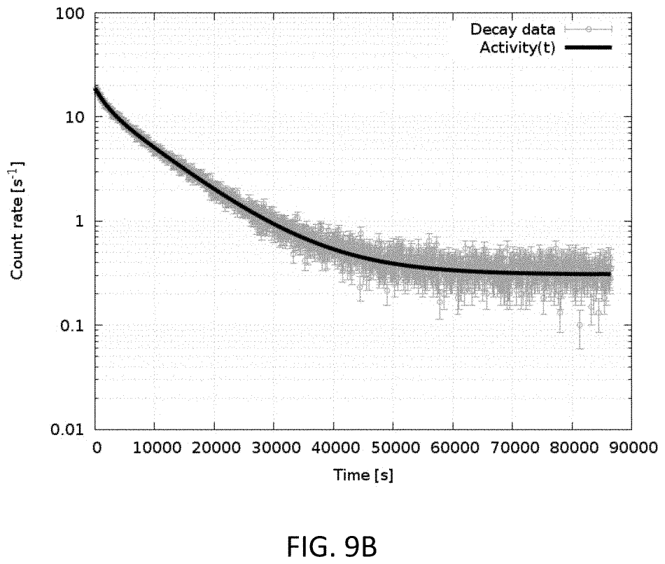

FIG. 4 shows an exemplary implementation of the method or the system 200 according to an aspect of the present invention, showing an electron accelerator 100, a controller 110 for controlling the operation of the electron accelerator 100, for example a personal computer or other type of data processing device, or a data processing and controlling equipment that is an integral part of the electron accelerator 100, an electron beam applicator 120, an electron beam 160, an isotope sample plate 130 that can be placed into the electron beam 160, for example but not limited to a copper plate 130, treatment couch 150, for example but not limited to a carbon fiber treatment couch. Moreover, preferably, a stable properly chelated copper isotope sample plate can be used for sample plate 130.

With the system 200 that is exemplarily shown in FIG. 4, experimental data from the medical oncology department of a Swiss hospital has shown the operation of the method by the production of radioactive isotopes (RI)⁶²Cu and/or ⁶⁴Cu when a sample of pure Copper was irradiated by a beam of 22 MeV photons from the electron accelerator facility in the oncology department of the Cantonal Hospital of Fribourg in Switzerland (Hopital Cantonal Fribourgeois “HFR”). Evidence of the radioactive isotopes, (RI) production, also referred to as radioisotope, radioactive nuclide, or radio nuclide, is provided through the measurements of the radiation from the two Copper radio nuclides and the two measured life-times are within 2% of their expected values. Also presented are experimental results about the production of the much sought after radionuclide ¹⁸F along with another ¹¹C in one shot, through a non-cyclotron or a nuclear reactor source.

System 200 can operate without any additional elements other than the electron accelerator 100 with the electron beam applicator 120 that are parts of a conventional oncology radiation system of a hospital. In this respect, no additional converters or other electron beam modifying devices are required, and the electron beam bath from the electron accelerator 100 to the sample 130 is unobstructed, thereby allowing production of short-lived RI for medical purposes on site without complicated additional operations and equipment.

The system for the generation of copper radio nuclides was included the following elements and arrangements: A 10 cm to 10 cm Copper (Cu) plate 130 with a thickness of 0.5 mm was placed under a broad electron beam 160 (at 22 MeV) from an electrode accelerator, for example a TrueBeam 2.7MR2 Linear Accelerator from Varian. The Copper plate 130 was centered in the beam that produced through a 15 cm to 15 cm applicator 120. The copper plate 130 was placed at a source-surface distance (SSD) of 100 cm. The plate 130 lay on the treatment couch 150 that was made of carbon fiber to reduce any other contribution to the measured activation. A maximum dose rate (1000 Monitor Units/min=1000 MU/min) was chosen by controller 110, corresponding to 10 Gy/min at 100 cm SSD. Then the Copper plate 130 as a target was irradiated for 20 minutes thus totaling 20,000 MU. As soon as the beam was stopped (after 20,000 MU) by controller 110, the chronometer was started to measure the activity and radiation expected from the production and decays of radio nuclides Cu⁶² and Cu⁶⁴. The detector used was a NaI(T1) 2.0″×2.0″ crystal gamma-scintillation detector.

For the method and system for the generation of RI ¹⁸F and ¹¹C using Teflon (C₂F₄) targets are as follows: Two sets of measurements were made with Teflon. A first Teflon sample weighing 13:105(10) gms was irradiated with 10,000 MU of the 22 MeV electron beam. To alleviate excessive intensity of the source and the dead time of our detector, a second Teflon weighing 3.205 gms was irradiated with only 4,000 MU by the same electron beam. For both Teflon experimental tests, the method included a step of placing the target in front of the detector for twenty-four (24) hours after having stopped the short irradiation. Zero time is the time when the beam stopped. A few minutes later the measurement started taking into account this zero time (starting point of the time scale). The software PRA.exe accumulated all the events with the time of appearance. Thus, after the measurement, it was feasible to analyze the spectrum (from 0 to 4 MeV) by focusing on a single part. Clearly the interesting part for both isotopes ¹¹C and ¹⁸F lies in the annihilation peak area (511 keV). Each Teflon target was irradiated at 1,000 MU/minute under the broad beam of 22 MeV electrons (Applicator 15×15). A short time (˜2 minutes) later, they were deposed in front of the detector for twenty-four (24) hours one after the other.

FIG. 3 shows the measured radiation activity in units of number of counts/min as a function of time, providing for evidence of the production of ⁶²Cu and ⁶⁴Cu radio nuclides. In the upper section of FIG. 3 data us shown for early times (up to 100 minutes) and in the lower section of FIG. 3 the same data are shown over the complete period of measurement (3000 minutes). A fit was performed and the following half-lives for ⁶²Cu and ⁶⁴Cu were determined from the activity curves.
(i) T_{1/2}[⁶²Cu]=(9:816±0:193) minutes;
Experimental value: 9.673 minutes:
(ii) T^{1/2}[⁶⁴Cu]=(760:562±18:31) minutes;
Experimental value: 762 minutes:

Clearly, there is more than satisfactory agreement between the data and theoretical expectations about the production of copper nuclides through the method proposed. For the generation of ¹⁸F and ¹¹C, a small sample of Teflon was irradiated by the photon beam as described above. Clear signals for the production of both radio nuclei are shown in FIG. 3. The life times are in very good agreement with their known values:

(A) half-life of ¹⁸F:
present experiment=6586.2 secs; known value=6582 secs;

(B) half-life of ¹¹C:
present experiment 1221.8 secs; known value=1213.8 secs;

As explained above, these results achieved confirm that electron accelerators commonly available at medical oncology centers around the world, can be used to produce the required amounts of radio nuclei in situ locally, when needed. It can therefore reduce the cost of production as well as that of transport and at the same time avoid the use of nuclear reactors or cyclotrons that can suffer from the unwanted production of nuclear waste. The copper plates 130 can be used repeatedly since both produced copper radio nuclides have a shelf life of only a few days. Thus, ordinary storage of copper plates 130 would be adequate and should require no special handling.

Next, different methods are described for the generation of radio isotopes. For example, a first method for giant dipole resonance (GDR) method is described for ⁶⁴Cu, ⁶²Cu production. As further discussed below, ⁶³Cu and ⁶⁵Cu are the two naturally occurring stable isotopes of Copper and the short half-life isotope ⁶⁴Cu is one of the radio-isotopes wanted in nuclear medicine both for imaging and for treatment of cancer, due to its decays both via β+(61% into ⁶⁴Ni) and β⁻(39% into ⁶⁴Zn) modes and producing only benign elements such as Nickel and Zinc.

With respect to the production of RI ⁶⁴Cu via GDR, the first method for producing this RI using an electron machine via one photon exchange GDR process producing a single neutron is schematically as follows:

e(p_1;s_1)→e(p_2;s_2)+γ*(E_γ;k_γ);

E_γ=(E_1−E_2);k_γ=|p_1−p_2|

γ*+⁶⁵Cu→(⁶⁵Cu)*→⁶⁴Cu+n;

It can be seen that only the stable A=65 Copper (and not the other, more than twice more abundant A=63 Copper) can produce the wanted radio isotope A=64 along with a single neutron. Spin parity considerations seem to favor this channel. The initial nuclear ground state of ⁶⁵Cu has J^{P}=3/2− and the initial photon has J^{P}=1+. The final state nuclear ground state ⁶⁴Cu has J^{P}=1+ and the final neutron has J^{P}=1=2+. According to the compilation of GDR cross-sections on nuclei[9], the parameters for the required process are as follows:

γ*+⁶⁵Cu→(⁶⁵Cu)*→⁶⁴Cu+n;
Peak photon energy E_{γ}(peak)˜18 MeV;
   Cross-section at the peak:
   σ_{(max)˜}150 milli-barns.

Of course, the above cross-section should be multiplied by 0:3 for the measurable cross-section since a given piece of Copper has only 30% of ⁶⁵Cu in it. Thus, approximately 45 milli-barns may be expected as the peak cross-section for producing ⁶⁴Cu nucleus. Very useful estimates of the number of neutrons produced per electron in the initial electron-energy interval of interest here (10÷20) MeV, see reference [12]. Roughly speaking, for a Copper target of thickness between (1÷4) radiation lengths [corresponding to the material thickness (13÷53) gm·/cm², the number of neutrons/electron ranges between (2÷7)×10⁻⁴ for an incident electron energy of about ˜20 MeV. To within a factor of two, we should expect the same ratio for the number of ⁶⁴Cu produced per electron of about 20 MeV.

Next, the production of RI 62Cu via GDR is described. There is a shorter lived radio isotope of Copper ⁶²Cu that can be GDR produced along with a neutron by ⁶³Cu:
⁶²Cu: Unstable; Half-life=9.67 minutes;
Z=29; N=33;
J^{P}=1+;
decays via β⁺ (positron) into ⁶²Ni;
with emission energy E=1315 KeV.

Its [98% decay] into positrons renders this RI as an excellent candidate for imaging and relabeling of molecules, whereas its almost total disappearance within less than an hour, renders Cu⁶² of less practical and more restricted use for treatment than Cu⁶⁴.

Next, a second GDR method for ⁶⁴Cu and ⁶²Cu production is described. The goal is to is to find stable isotopes of an element with a certain charge (Zₚₐᵣₑₙₜ) that can produce the sought for radio nuclide(s) of charge (Z_{daughter}≠Zₚₐᵣₑₙₜ) different from that of the parent nucleus, by the use of the GDR mechanism. Of course, since ΔZ≠0, the rest of the final state would have to have a non-vanishing charge and thus cannot be a single neutron. While this implies a reduction in the nuclide production cross-section, it has the distinct advantage that expensive isotope separations would not be required. With suitable amounts of extra parent material, higher electron luminosity and increased bombardment time, the problem of reduction in the cross-section can be largely circumvented. Let us apply the above towards producing Copper radio nuclides (charge Z=29) through the bombardment of a parent nucleus Zinc (charge Z=30). There are the following four (4) stable isotopes of Zinc of relevance here:
(i)⁶⁴Zn: natural concentration=49.2%;
(ii)⁶⁶Zn: natural concentration=27.7%;
(iii)⁶⁷Zn: natural concentration=4%;
(iv)⁶⁸Zn: natural concentration=18.5%;

For the purpose at hand, let us consider the following GDR-induced final state reactions.

γ*+⁶⁸₃₀Zn→p+⁶⁷₂₉Cu;

γ*+⁶⁶₃₀Zn→d+⁶⁴₂₉Cu;

γ*+⁶⁶₃₀Zn→n+p+⁶⁴₂₉Cu;

γ*+⁶⁴₃₀Zn→d+⁶²₂₉Cu;

γ*+⁶⁴₃₀Zn→n+p⁶²₂₉Cu.

The production of the nucli ⁶⁷Cu through the proton mode as well as the production of nuclides ⁶⁴Cu and ⁶²Cu, via both the deuteron and the (np) modes have been measured. It was found that the deuteron production in the threshold region is anomalously “large.” At 22 MeV, the production cross-section for the nuclide ⁶⁷Cu from Zinc, as shown in the equation above, is 18 milli-barns. On the other hand, at similar energies, the peak production cross-sections for the nuclides ⁶⁴Cu, ⁶²Cu through the d and (np) modes, are about three (3) milli-barns, a factor of about six (6) smaller. However, folding in the natural concentrations of the various Zinc isotopes, the effective production cross-sections of ⁶⁷Cu:⁶⁴Cu:⁶²Cu should be roughly (3:33:0:83:1:48) milli-barns, respectively. For proton associated photo-production of ⁶⁷Cu, see[12] for further details. A chemical separation of the produced Copper nuclides from Zinc was already performed in reference [14] quite successfully. The details can be found in Appendix of reference [14]. Presently, more modern chemical methods can be employed for this purpose, see reference [16], [17].

With respect to isotopic separation, RI produced either by reactors or by nuclear accelerators that use proton or deuteron beams need to be chemically separated from the parent nuclei before their medical use. Similarly, the above discussed three (3) U.S. Patent Publications that relate to RI production from electron accelerators teach us to perform an isotopic separation of the produced RI from the parent nuclei. In contrast thereto, the herein presented method and system obviates any need for isotopic separation. For example, the produced copper RI[Cu⁶² & Cu⁶⁴] can be injected together with properly chelated copper: In this respect, the RI as can be used as tracers to locate the tumor and the accompanying chelated copper can be used for a cure of the tumor.

Next, the simultaneous electro-production of ¹⁸F and ¹¹C radio-nuclides are described, as discussed above. As a proof of concept experiment for the production of another much sought after tracer radio nuclide, the production of ¹⁸F using an electron accelerator has been investigated. As can be seen from the following discussion, we use a solid target in contrast to an aqueous solution used routinely. In the detailed review published by International Atomic Energy Agency, Vienna, Austria (IAEA) of 2009, regarding the medical applications of radio nuclides, it is stated that the present medical demand for ¹⁸F far exceeds its availability [17]. Therefore, this alternative embodiment for the method is useful as we can produce it in tandem with another medically important radio isotope ¹¹C. Let us recall some aspects of stable fluorine and its one isotope relevant for medicine:
(1) ¹⁹F: (Stable): natural concentration=100%; Z=9; N=10; J^{P}=½+;
(2) ¹⁸F: (Unstable); Half-life=109.74\ minutes; Z=9; N=9; J^{P}=1⁺;
decays via: (i) β⁺ (positron)\(96.9%) into ¹⁸O;
(ii) electron capture (3.14%) into ¹⁸O.

Due to its fast decay rate, the “shelf life” of ¹⁸F, limited to two half-lives, is only about four (4) hours and distribution of such radio isotopes presents logistic problems. It is for this reason that IAEA recommended establishment of centralized production facilities. This 2009-report stated the following: “the possibility of large scale production of radio isotopes from photons seemed very unlikely a decade ago, while now that possibility seems, at least at the proof-of-concept level, highly probable”, see reference [17].

Given the technical advances made in the decade after the above report was published, according to an aspect of the present invention, a method is proposed to establish and equip existing radiation oncology departments towards in situ production of short-lived radio nuclides employing their in-house electron accelerators, suitably modified for this purpose. Specifically, according to some aspects of the herein presented methods and systems, a novel approach has been provided for generating short-lived radio nuclides for medical uses in a variety of ways. According to some aspects of the herein presented methods and systems, a giant dipole resonance is employed in the nuclei based on efficient use of extensive theoretical and experimental work, to thereby use existing an unmodified electron accelerators in hospitals that are usually used for nuclear medicine to generate the required photon beams that are suitable for the production of the isotopes, without the need of any additional specific equipment or specific target samples, for example as shown in the three (3) cited U.S. patent publications above.

Moreover, the solutions proposed in the three (3) cited U.S. patent publications above, would actually render local production of an RI by a hospital practically impossible. For example, according to some aspects of the present methods and systems, no special manufacture and/or assembly of target materials with a complicated structure is required, as shown in such as those described in nineteen (19) diagrams as discussed in the U.S. patent publication to Takei Ito. Also, according to some aspects of the present methods and systems, no nanostructured materials are required as discussed in U.S. patent publication to Wells et al. Moreover, according to some aspects of the present methods and systems, no additional and special converters are required for the electron beam as discussed in U.S. patent publication to Charles S. Holden. In fact, none of these three (3) U.S. patent publications have the specific features for the use and operation in a hospital much less to devise a method that might enable a hospital to produce RI locally in situ. No specific data for electron beams of hospitals for RI production exists whereas with the present method and system, real production data is presented for the required needed medical RI [Cu⁶², Cu⁶⁴, F¹⁸, Cu¹¹] obtained using a broad beam electron accelerator routinely available at a normal oncology hospital.

Moreover, different ¹⁸F production mechanisms have been used. The two major nuclear reaction processes invoked for this purpose are the following:
(i)\p+¹⁸O→n+¹⁸F; [incident proton\energy=(11-17)\MeV];
(ii)\d+²⁰Ne→α+¹⁸F;\[incident deuteron\energy=(8-14)\MeV].

While the proton-initiated process has a larger cross-section, it requires “enriched” water (H₂¹⁸ O) that is cumbersome and expensive, as the latter constitutes only approximately 2% of ordinary water (H₂¹⁶ O). Moreover, fluorine in the aqueous state generated via process (i) as referred to the above equation must be de-solvated & activated by treatment with a chelator, for example Kryptfix 2.2.2, to bind the potassium and “free” the fluoride ions for direct nucleophilic labeling reactions. Process (ii) on the other hand, produces [¹⁸F]F₂ that can be directly used for electrophilic labeling.

It should also be noted that any hadronic initiated radio nuclide production process or method, for example initiated by a proton or a deuteron beam, can give rise to unwanted radio nuclides if the target has contamination from heavier materials. For example, a production of an undesired radio isotope ⁵⁵Co (half-life 17.54 hours) has been shown [22] due to the presence of iron in an aluminum foil target (Al₂¹⁸O₃) that was irradiated by a proton beam.

The GDR process for the production of ¹⁸F that has been experimented and discussed herein, and is an aspect of the present invention, is to irradiate polytetrauoroethylene [(C₂F₄)n], commonly known under the trade name Teflon, by an electron beam. There are two (2) fluorine atoms for each carbon atom, by weight about 76% fluorine and 24% carbon and the substance is rather light (density=2.2 gm/cm³). The chosen target material has the great advantage of not only producing ¹⁸F (from the parent ¹⁹F) but also ¹¹C from its parent ¹²C. This allows to produce, based on the isotope sample including Teflon, a fluorine isotope F18 and a carbon isotope C11 together.

As both produced radio nuclides are of medical imaging interest, this reaction is unique in this respect and offers a distinct advantage over previous methods. Next, a method is described for analyzing three (3) plates, that potentially can serve as an isotope sample plate 130 for the system 200, where the plates are made of unknown materials. The goal is to find the materials inside of the three (3) plates using the NaI detector. Each of the three (3) unknown plates are placed in front of the detector, for example electron accelerator 100, during twenty-four (24) hours one after the other. From experience of measurement without anything in front of the detector, one can say that this probe does not include contaminated material other that the normal (natural) background. Then each of the unknown plates (1, 2 and 3) are irradiated for ten (10) minutes under a broad beam of 22 MeV electrons using an applicator 15×15 with 1000 MU. Thereafter they were disposed in front of the detector during twenty-four (24) hours one after the other. The strategy chosen was to concentrate on that annihilation peak and zooming on it evaluate the time dependency of events coming in that special portion of the spectrum.

The counts (and associated error) during one minute were taken for the whole range of 24 hours and just divided by 60 to get counts per second [s⁻¹]. The fitted function for activity is expressed by the following equation:

$$Activity ( t ) = {A}_{0} \cdot {e}^{- t \cdot \frac{ln ( 2 )}{{T}_{1 \text{/} 2 , A}}} + {B}_{0} \cdot {e}^{- t \cdot \frac{ln ( 2 )}{{T}_{1 \text{/} 2 , B}}} + bck$$

As one can see in the previous equation: two different decays (A and B) were used for each plate and the background was also introduced in the fit (parameter bck). Next, six (6) tables are presented that show the course of the fit for each plate and the results of the fit for each plate.

TABLE 1
The course of the fit for plate 1.

| Course of the curve adjustement | value |
|---|---|
| degrees of freedom (FIT_{NDF}) | 1435 |
| rms of residuals (FIT_{STDFIT}) = sqrt(WSSR/ndf) | 0.996853 |
| variance of residuals (reduced chisquare) = WSSR/ndf | 0.993716 |
| p-value of the Chisq distribution (FIT_{P}) | 0.562078 |

TABLE 2
The results of the fit for plate 1.

| Final set of parameters | Asymptotic Standard Error | |
|---|---|---|
| A₀ = 31.6055 | ±0.2816 | (0.8909%) |
| B₀ = 9.54848 | ±0.9019 | (9.445%) |
| T½, A = 1566.23 | ±9.82 | (0.627%) |
| T½, B = 135.333 | ±20.31 | (15.01%) |
| bck = 0.822919 | ±0.00332 | (0.4034%) |

TABLE 3
The course of the fit for plate 2.

| Course of the curve adjustement | value |
|---|---|
| degrees of freedom (FIT_{NDF}) | 1435 |
| rms of residuals (FIT_{STDFIT}) = sqrt(WSSR/ndf) | 1.01851 |
| variance of residuals (reduced chisquare) = WSSR/ndf | 1.03736 |
| p-value of the Chisq distribution (FIT_{P}) | 0.158436 |

TABLE 4
The results of the fit for plate 2.

| Final set of parameters | Asymptotic Standard Error | |
|---|---|---|
| A₀ = 18.0854 | ±0.2958 | (1.636%) |
| B₀ = 20.5745 | ±0.2237 | (1.087%) |
| T½, A = 1301.63 | ±37.85 | (2.908%) |
| T½, B = 6817.31 | ±45.59 | (0.6687%) |
| bck = 0.785237 | ±0.005012 | (0.6383%) |

TABLE 5
The course of the fit for plate 3.

| Course of the curve adjustement | value |
|---|---|
| degrees of freedom (FIT_{NDF}) | 1435 |
| rms of residuals (FIT_{STDFIT}) = sqrt(WSSR/ndf) | 1.05319 |
| variance of residuals (reduced chisquare) = WSSR/ndf | 1.10921 |
| p-value of the Chisq distribution (FIT_{P}) | 0.00227449 |

TABLE 6
The results of the fit for plate 3.

| Final set of parameters | Asymptotic Standard Error | |
|---|---|---|
| A₀ = 18.611 | ±0.2729 | (1.466%) |
| B₀ = 8.64205 | ±0.6996 | (8.095%) |
| T½, A = 1522.26 | ±15.53 | (1.02%) |
| T½, B = 163.196 | ±21.56 | (13.21%) |
| bck = 0.800653 | ±0.00344 | (0.4297%) |

It has been observed that that plate 1 and 3 are very similar and present data compatible with a produced decay of a mix of ¹⁵O (T½:122.24s) and ¹¹C (T½:1221.8s). The plate 2 is different and as we fitted also two components. Perhaps it would have been better to take three components but statistics was insufficient to justify this. Plate 2 shows the ¹¹C (T½:1221.8s) and ¹⁸F (T½:6586.2s).

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

### REFERENCES

[1] A. Widom, J. Swain and Y. Srivastava, Neutron production from the fracture of piezoelectric rocks, J. Phys. G. Nucl. Part. Phys. 40, 015006 (2013); arXiv: 1109.4911v2 [phys. gen-ph]
[2] J. Swain, A. Widom, Y. Srivastava, Electro-strong Nuclear Disintegration in Condensed Matter, arXiv: nucl-th 1306.516v1
[3] A. Widom, J. Swain, Y. Srivastava, Photo-disintegration of the iron nucleus in fractured magnetite rocks with magnetostriction, Meccanica, 50, 1205 (2015); arXiv:physics.gen-ph 1306.6286v1.
[4] D. Cirillo, A. Widom, Y. Srivastava, J. Swain, et. al., Experimental Evidence of a Neutron Flux Generation in a Plasma Discharge Electrolytic Cell, Key Engineering Materials 495 104 (2012); D. Cirillo, A. Widom, Y. Srivastava, J. Swain, et. al., Water Plasma Modes and Nuclear Transmutations on the Metallic Cathode of a plasma discharge in an Electrolytic Cell. Key Engineering Materials 495 124 (2012).
[5] A. Widom, Y. N. Srivastava, J. Swain, G. de Montmollin, L. Rosselli, Reaction products from electrode Fracture and Coulomb explosions in batteries, Engineering Fracture Mechanics, 184 (2017) 88100.
[6] A. Widom, Y. N. Srivastava, J. Swain, G. de Montmollin, Tensile and explosive properties of current carrying wires, Engineering Fracture Mechanics, 197 (2018) 114.
[7] H. Ejiri and S. Date, Coherent photo-nuclear reactions for isotope transmutation, arXiv: 1102.4451.
[8] H. Schwoerer et al., Lasers and Nuclei, Lecture Notes in Physics 694, Springer-Verlag, 2006.
[9] Atlas of giant dipole resonances, parameters and graphs of photo-nuclear reaction cross-sections, A. Varlamov, V. Varlamov, D. Rudenko and M. Stepanov, INDC(NDS)-394, International Atomic Energy Agency, Vienna, Austria (1999).
[10] C. B. Fulmer et al., Photo-nuclear Reactions in Iron and Aluminum Bombarded with High-Energy Electrons, Phys. Rev. C2 (1970) 1371.
[11] Acoustic, Electromagnetic, Neutron Emissions from Fracture and Earthquakes, Editors, A. Carpinteri, G. Lacidogna and A. Manuello; Springer Berlin (2015).
[12] W. Barber and W. George, Neutron yields from targets bombarded by electrons, Phys. Rev., 116 (1951) 1551.
[13] L. Evangelista and M. Luigi and G. Cascini, New Issues for Copper-64: from Precursor to Innovative Pet Tracers in Clinical Oncology, Current Radiopharmaceuticals, 6 (2013) 000.
[14] J. Goldemberg and L. Marquez, Measurements of (γ, d) and (γ, np$) reactions in the threshold region, Nuclear Physics, 7 (1958) 202.
[15] V. Starovoitova, T. Grimm and P. Cole, Accelerator-based photoproduction of promising beta-emitters Cu67 and Sc47, J. of Radioanalytical and Nuclear Chemistry, 305 (2015) 127.
[16] A. Dasgupta, L. Mausner and S. Srivastava, A new separation procedure for Copper 67 from proton irradiated Zinc, Int. J. of Radiation: Applications and Instrumentation. Part A. Applied Radiation and Isotopes, 42 (1991) 371.
[17] IAEA report, Cyclotron Produced Radionuclides: Principles and Practice; Technical Reports Series No. 465, Vienna(2009); published at https://www-pub.iaea.org.
[18] O. Jacobson, D. O. Kiesewetter and X. Chen, Fluorine-18 Radiochemistry, Labeling Strategies and Synthetic Routes, Bioconjugate Chem., 26 (2015) 1.
[19] E. L. Cole, M. N. Stewart, R. Littich, R. Hoareau and P. J. H. Scott, Radiosyntheses using Fluorine-18: the Art and Science of Late Stage Fluorination, Curr Top Med Chem., 14 (2014) 875.
[20] R. H. Press et al, The Use of Quantitative Imaging in Radiation Oncology: A Quantitative Imaging Network (QIN) Perspective, Int J Radiat Oncol Biol Phys. 102 (2018)1219.
[21] V. Cardoso, D. Correia, C. Ribeiro, M. Fernandes and S. Lanceros-M'endez, Fluorinated polymers as smart materials for advanced biomedical applications, Polymers, 10 (2018) 161.
[22] E. Hess, S. Tak'acs, B. Scholten, F. T'ar'kanyi, H. Coenen and S. Qaim, Excitation function of the¹⁸O(p,n)¹⁸F nuclear reaction from threshold up to 30 MeV, Radiochim. Acta, 89 (2001) 357.

1. A method for producing medical radioactive isotopes by an electron beam using an electron accelerator via a one-photon exchange into target nuclear giant dipole resonances (GDR), the method comprising the steps of:
providing an isotope sample; and
accelerating electrons by the electron accelerator to a peak photon energy of above 10 MeV to impinge on the isotope sample including stable copper to generate two copper radioisotopes Cu62 and Cu64 together.

2. The method of claim 1, wherein the isotope sample includes a stable properly chelated copper isotope sample.

3. The method of claim 1 further comprising the step of:
using the two copper radioisotopes Cu62 and Cu64 as a radio-tracer for positron emission tomography (PET).

4. The method of claim 3, wherein the step of using does not require a separation of the two copper radioisotopes Cu62 and Cu64 from the isotope sample.

5. The method of claim 1, wherein in the step of accelerating, the cross-section at the peak photon energy of the accelerated electrons is approximately 45 milli-barns.

6. The method of claim 1, wherein an electron path between the electron accelerator and the isotope sample is direct and unobstructed by a converter.

7. A method for producing medical radioactive isotopes by an electron beam using an electron accelerator via a one-photon exchange into target nuclear giant dipole resonances (GDR), the method comprising the steps of:
providing an isotope sample; and
accelerating electrons by the electron accelerator to a peak photon energy of above 10 MeV to impinge on the isotope sample including Teflon, to generate a fluorine isotope F18 and a carbon isotope C11 together.

8. The method of claim 7, wherein the isotope sample includes a Teflon to provide stable carbon and fluorine as target material.

9. The method of claim 7 further comprising the step of:
using the fluorine radioisotope F18 and the carbon isotope C11 as a radio-tracer for positron emission tomography (PET).

10. The method of claim 9, wherein the step of using does not require a separation of the fluorine radioisotope F18 and the carbon isotope C11 from the isotope sample.

11. The method of claim 7, wherein in the step of accelerating, the cross-section at the peak photon energy of the accelerated electrons is approximately 45 milli-barns.

12. The method of claim 7, wherein an electron path between the electron accelerator and the isotope sample is direct and unobstructed by a converter.

13. A system for producing radioactive isotopes comprising:
an electron machine configured to perform one-photon exchange excitation giant dipole resonances (GDR) and configured to accelerate electrons by an electron accelerator to a peak photon energy of above 10 MeV, wherein the electron accelerator is configured to impinge the accelerated electrons onto a isotope sample, the isotope sample including stable copper to generate two copper radioisotopes Cu62 and Cu64 together, or the isotope sample including Teflon to generate a fluorine isotope F18 and a carbon isotope C11 together.

14. The system of claim 13, wherein the isotope sample includes a stable properly chelated copper isotope sample.

15. The system of claim 13, wherein the isotope sample includes a Teflon to provide stable carbon and fluorine as target material.

16. The system of claim 11, wherein an electron path between the electron accelerator and the isotope sample is direct and unobstructed by a converter.
